(19) United States
(12) Patent Application Publication
(10) Pub. No.: US 2013/0082913 A1
(43) Pub. Date: Apr. 4, 2013

(54) VOLTAGE SELECTION APPARATUS AND VOLTAGE SELECTION METHOD

(71) Applicant: Raydium Semiconductor Corporation, Hsinchu (TW)

(72) Inventors: Chien-Ru Chen, Ligang Township (TW); Ying-Lieh Chen, Tainan City (TW)

(73) Assignee: Raydium Semiconductor Corporation, Hsinchu (TW)

(21) Appl. No.: 13/633,278

(22) Filed: Oct. 2, 2012

(30) Foreign Application Priority Data
Oct. 3, 2011 (TW) 100135798

(51) Int. Cl. G09G 3/36

(52) U.S. Cl. 345/88

(57) ABSTRACT

A voltage selection apparatus and a voltage selection method applied in a driving circuit of a liquid crystal display are disclosed. The voltage selection apparatus includes a generating module, a selection module, and a setting module. The generating module generates a first curve, a second curve, and a third curve corresponding to gamma curves of R pixel, G pixel, and B pixel of the liquid crystal display under different divided voltages respectively. The selection module selects at least two common curves from the first curve, the second curve, and the third curve, and the at least two common curves have a shared region corresponding to a common divided voltage range. The setting module sets at least two pixels corresponding to the at least two common curves to use a voltage dividing resistor string in the common divided voltage range to provide voltage dividing points.

### BACKGROUND OF THE INVENTION

1. Field of the Invention

The invention relates to liquid crystal display; in particular, to a voltage selection apparatus and voltage selection method applied in a driving circuit of a liquid crystal display to reduce the waste of layout space of the digital-analog converter in conventional driving circuit and effectively improve the phenomenon of color shift.

2. Description of the Related Art

In general, the liquid crystals of the liquid crystal display are controlled by a voltage to change their alignment, and the back light emitted from the backlight module passes through the liquid crystals and the red (R) sub-pixel, green (G) sub-pixel, or blue (B) sub-pixel of the pixels respectively to form the colors displayed on the liquid crystal display. Therefore, if different divided voltages are provided to the red sub-pixel, green sub-pixel, and blue sub-pixel of the pixels respectively, the liquid crystal display can provide a gray scale displaying effect formed by the red sub-pixel, green sub-pixel, and blue sub-pixel of the pixels.

In practical applications, the liquid crystal display usually has the phenomenon of color shift, that is to say, the colors displayed on the liquid crystal display are shifted to blue, red, or green. This is because that if the red sub-pixel, green sub-pixel, and blue sub-pixel of the pixels of the liquid crystal display are operated under the same divided voltage, the problem of poor color performance is easily formed. Therefore, three independent resistor strings are used to provide voltage dividing points the red sub-pixel, green sub-pixel, and blue sub-pixel need respectively, so that the color shift phenomenon of the liquid crystal display can be improved by adjusting the divided voltages provided to the red sub-pixel, green sub-pixel, and blue sub-pixel respectively.

For example, as shown in FIG. 1A, in the prior art, three independent resistor strings RS1, RS2, and RS3 are used to provide voltage dividing points to the red sub-pixel, green sub-pixel, and blue sub-pixel of the pixel respectively. If there are 255 voltage dividing points PR1˜PR255, PG1˜PG255, and PB1˜PB255 disposed on the three independent resistor strings RS1, RS2, and RS3 respectively, there will be totally 765 voltage dividing points. In addition, if there are a positive digital-analog converter DAC+ and a negative digital-analog converter DAC−, the number of the independent resistor strings needed will become 6, and there will be totally 1530 voltage dividing points including the voltage dividing points PR+1˜PR+255, PR−1˜PR−255, PG+1˜PG+255, PG−1˜PG−255, PB+1˜PB+255, and PB−1˜PB−255.

However, for the positive digital-analog converter DAC+ and the negative digital-analog converter DAC−, three times of the original area is needed to dispose the 6 independent resistor strings, and the total number of the voltage dividing points needed for the 6 independent resistor strings will also become 3 times. Please refer to FIG. 1B, the source driver SD has the structure that two adjacent channels CH1 and CH2 share the same set of digital-analog converter DAC including the positive digital-analog converter DAC+ and the negative digital-analog converter DAC−, the area used by the digital-analog converter DAC shared by the channels CH1 and CH2 of FIG. 1B will also become 3 times of the original area. However, a lot of space (e.g., the hatched region in FIG. 1B) will not be used, and the layout space of the digital-analog converter will be wasted, and it will be hard to reduce the volume of the source driver.

### SUMMARY OF THE INVENTION

Therefore, the invention provides a voltage selection apparatus and a voltage selection method applied in a driving circuit of a liquid crystal display to solve the above-mentioned problems occurred in the prior arts.

A first embodiment of the invention is a voltage selection apparatus. In this embodiment, the voltage selection apparatus includes a generating module, a selection module, and a setting module. The generating module generates a first curve, a second curve, and a third curve corresponding to gamma curves of R pixel, G pixel, and B pixel of the liquid crystal display under different divided voltages respectively. The selection module selects at least two common curves from the first curve, the second curve, and the third curve, and the at least two common curves have a shared region corresponding to a common divided voltage range. The setting module sets at least two pixels corresponding to the at least two common curves to use a voltage dividing resistor string in the common divided voltage range to provide voltage dividing points.

In an embodiment, the at least two common curves is a combination of the first curve, the second curve, and the third curve, a combination of the first curve and the second curve, a combination of the first curve and the third curve, or a combination of the second curve and the second curve.

In an embodiment, the divided voltage provided to the voltage dividing resistor string is directly provided into the driving circuit from outside, or generated by a divided voltage generator in the driving circuit via a way of outside programming.

In an embodiment, the shared region comprises all of the at least two common curves.

In an embodiment, the shared region comprises a part of the at least two common curves, and the at least two common curves also have a non-shared region corresponding to a non-common divided voltage range.

In an embodiment, the setting module sets that the at least two pixels corresponding to the at least two common curves use different voltage dividing resistor strings in the non-common divided voltage range to provide voltage dividing points.

In an embodiment, the selection rule is related to a degree of closeness or a degree of similarity among the first curve, the second curve, and the third curve.

A second embodiment of the invention is a voltage selection method. In this embodiment, the voltage selection method is applied in a driving circuit of a liquid crystal display. The voltage selection method includes steps of: generating a first curve, a second curve, and a third curve corresponding to gamma curves of R pixel, G pixel, and B pixel of the liquid crystal display under different divided voltages respectively; selecting at least two common curves from the first curve, the second curve, and the third curve according to a selection rule, and the at least two common curves have a shared region corresponding to a common divided voltage range; setting at least two pixels corresponding to the at least two common curves to use a voltage dividing resistor string in the common divided voltage range to provide voltage dividing points.

Compared to the prior art, in the voltage selection apparatus and the voltage selection method of the invention, at least two of the three gamma curves (R, G, B) will be close or overlapped in some divided voltage ranges, and the sub-pixels corresponding to the at least two of the three gamma curves will share the same resistor strip to provide voltage dividing points. Not only the divided voltages provided to the R sub-pixel, G sub-pixel, and B sub-pixel of each pixel of the liquid crystal display can be adjusted to solve the color shift problem, but also the area and the number of voltage dividing points needed for resistor strips can be reduced. Therefore, the area used by the digital-analog converter of the source driver will be reduced to prevent the waste of layout space of the digital-analog converter in conventional driving circuit.

The advantage and spirit of the invention may be understood by the following detailed descriptions together with the appended drawings.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1A illustrates that three independent resistor strings are used to provide voltage dividing points to the red sub-pixel, green sub-pixel, and blue sub-pixel of the pixel respectively in the prior art.

FIG. 1B illustrates a schematic diagram of the layout space of the digital-analog converter being wasted in the prior art.

FIG. 2 illustrates a functional block diagram of the voltage selection apparatus in the invention.

FIG. 3A shows the gamma curves corresponding to the R sub-pixel, G sub-pixel, and B sub-pixel of a pixel of the liquid crystal display under different divided voltages respectively in an embodiment.

FIG. 3B illustrates a schematic diagram of the layout space of the digital-analog converter being saved in an embodiment.

FIG. 4A shows the gamma curves corresponding to the R sub-pixel, G sub-pixel, and B sub-pixel of a pixel of the liquid crystal display under different divided voltages respectively in an embodiment.

FIG. 4B illustrates a schematic diagram of the layout space of the digital-analog converter being saved in another embodiment.

FIG. 5A illustrates the gamma curves corresponding to the R sub-pixel, G sub-pixel, and B sub-pixel of a pixel of the liquid crystal display under different divided voltages respectively in another embodiment.

FIG. 5B illustrates a schematic diagram of the layout space of the digital-analog converter being saved in another embodiment.

FIG. 5C illustrates the gamma curves corresponding to the R sub-pixel, G sub-pixel, and B sub-pixel of a pixel of the liquid crystal display under different divided voltages respectively in another embodiment.

FIG. 5D illustrates a schematic diagram of the layout space of the digital-analog converter being saved in another embodiment.

FIG. 6A illustrates that the divided voltage is directly provided into the source driver from outside.

FIG. 6B illustrates that the divided voltage is generated by a divided voltage generator in the source driver.

FIG. 7 illustrates a flowchart of the voltage selection method of the invention.

### DETAILED DESCRIPTION

A first embodiment of the invention is a voltage selection apparatus. In this embodiment, the voltage selection apparatus is applied in a driving circuit of a liquid crystal display, but not limited to this.

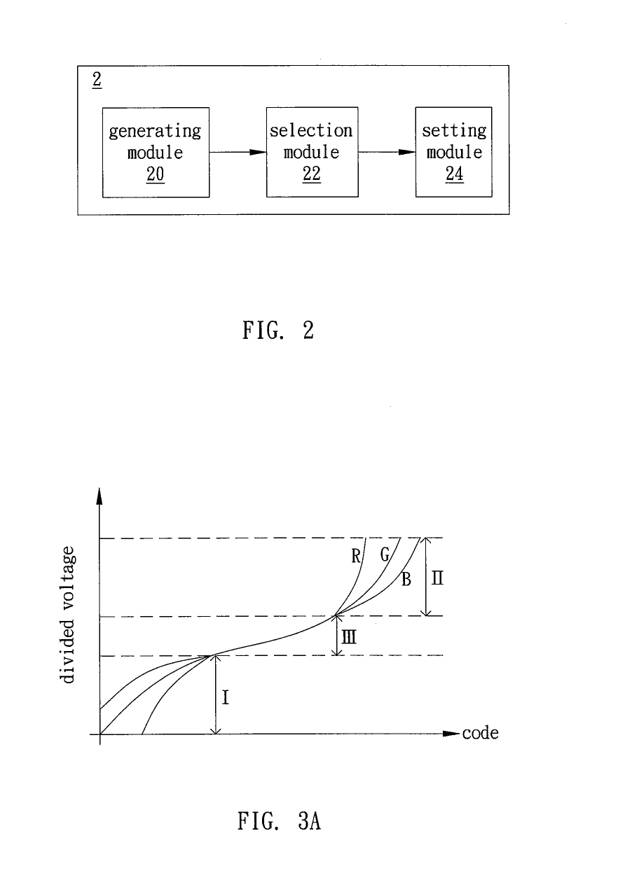

Please refer to FIG. 2. FIG. 2 illustrates a functional block diagram of the voltage selection apparatus. As shown in FIG. 2, the voltage selection apparatus 2 includes a generating module 20, a selection module 22, and a setting module 24. The selection module 22 is coupled to the generating module 20; the setting module 24 is coupled to the selection module 22. The generating module 20 is used for generating a first curve, a second curve, and a third curve corresponding to gamma curves of R sub-pixel, G sub-pixel, and B sub-pixel of the liquid crystal display under different divided voltages respectively.

The selection module 22 is used for selecting at least two common curves from the first curve, the second curve, and the third curve according to a selection rule, and the at least two common curves have a shared region corresponding to a common divided voltage range. In fact, the selection rule can be related to a degree of closeness or a degree of similarity among the first curve, the second curve, and the third curve, but not limited to this. The setting module 24 is sued for setting at least two pixels corresponding to the at least two common curves to use a voltage dividing resistor string in the common divided voltage range to provide voltage dividing points. The shared voltage dividing resistor strip includes a plurality of resistors connected in series, and the types and number of the resistors can be adjusted based on practical needs without specific limitations.

It should be noticed that the shared region may include all of the at least two common curves or a part of the at least two common curves. If the shared region includes a part of the at least two common curves, it means that the at least two common curves also have a non-shared region corresponding to a non-common divided voltage range. At this time, the setting module 24 will set that the at least two pixels corresponding to the at least two common curves use different voltage dividing resistor strings in the non-common divided voltage range to provide voltage dividing points. In practical applications, the non-shared region between the at least two common curves can be any regions on the at least two common curves, such as two ends or central region of the at least two common curves.

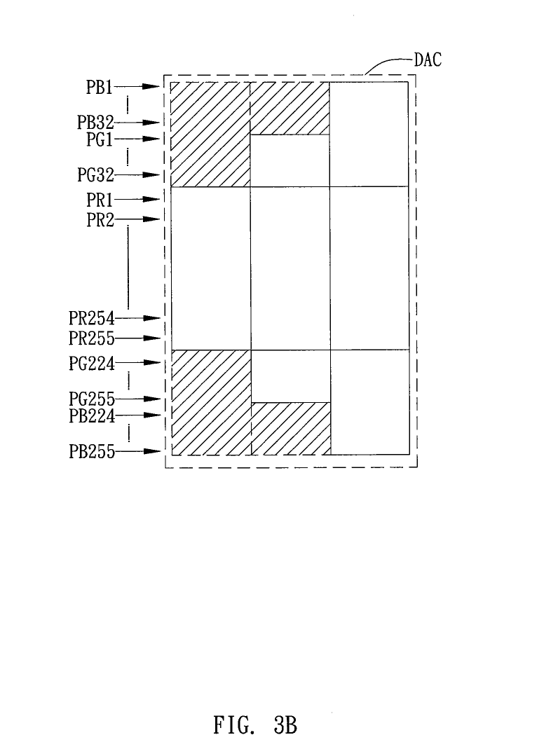

Please refer to FIG. 3A. FIG. 3A shows the gamma curves corresponding to the R sub-pixel, G sub-pixel, and B sub-pixel of a pixel of the liquid crystal display under different divided voltages respectively in an embodiment. As shown in FIG. 3A, in the lower divided voltage range I and the higher divided voltage range II, the distances among the R, G, B gamma curves will be larger. Therefore, if the same divided voltage is provided to the R sub-pixel, G sub-pixel, and B sub-pixel of the pixel, and the divided voltage is in the lower divided voltage range I or the higher divided voltage range II, the color lightness difference among the R sub-pixel, G sub-pixel, and B sub-pixel of the pixel will become larger, and this the phenomenon of color shift will seriously affect the quality of image displayed by the liquid crystal display. Therefore, in the lower divided voltage range I and the higher divided voltage range II, three independent resistor strips will still be used to provide voltage dividing points for the R sub-pixel, G sub-pixel, and B sub-pixel of the pixel to adjust the divided voltages provided to the R sub-pixel, G sub-pixel, and B sub-pixel of the pixel to solve the color-shift problem.

However, three independent resistor strings are used to provide voltage dividing points the red sub-pixel, green sub-pixel, and blue sub-pixel need respectively in all divided voltage ranges, this will cause the waste of the layout space of the digital-analog converter in the source driver. In addition, as shown in FIG. 3A, in the middle divided voltage range III, the distances among the R, G, B gamma curves will be small, or even they are overlapped. That is to say, even the same divided voltage is provided to the R, G, B sub-pixels, if the provided divided voltage is in the divided voltage range III, the color lightness differences among the R, G, B sub-pixels of the pixel are small, and the phenomenon of color shift will be not formed. Therefore, it is unnecessary to use the three independent resistor strings to provide voltage dividing points the red sub-pixel, green sub-pixel, and blue sub-pixel need respectively. If the provided divided voltage is in the divided voltage range III, but the three independent resistor strings are still used to provide voltage dividing points the red sub-pixel, green sub-pixel, and blue sub-pixel need respectively, it will cause the waste of the layout space of the digital-analog converter in the source driver.

Therefore, in the divided voltage range III, the R, G, B sub-pixels of the pixel can share the same resistor strip to provide the voltage dividing points; therefore, the area needed to dispose the resistor strip can be largely reduced and the number of the voltage divided points of the resistor strip can be reduced, so that the area used by the DAC of the source driver can be reduced as shown in FIG. 3B, and the unused space is only the hatched region in FIG. 3B, to effectively avoid the waste of the layout space of the DAC.

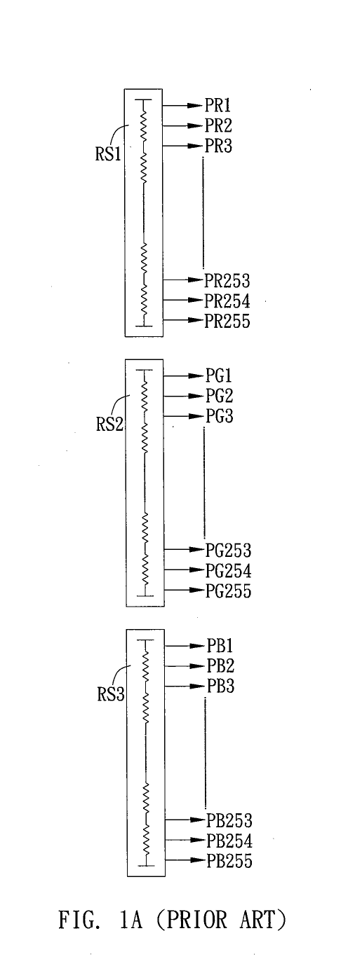

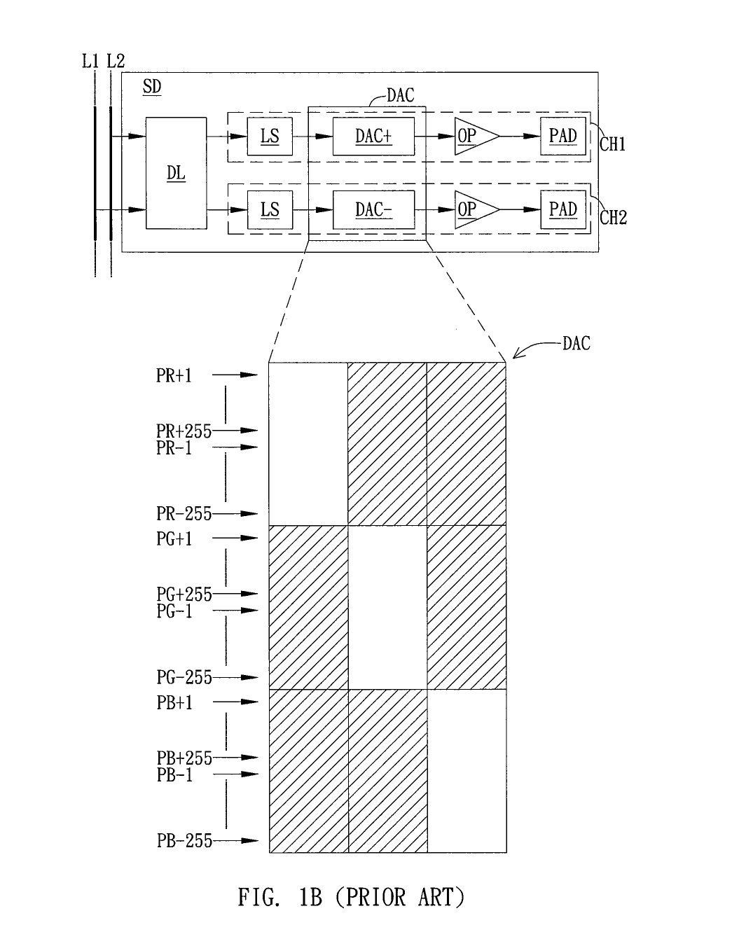

In the prior art, as shown in FIG. 1, if there are 255 voltage dividing points PR1˜PR255, PG1˜PG255, and PB1˜PB255 disposed on the three independent resistor strings RS1, RS2, and RS3 respectively, there will be totally 765 voltage dividing points. As to the invention, three independent resistor strings are used to provide voltage dividing points the red sub-pixel, green sub-pixel, and blue sub-pixel need respectively in the lower divided voltage range I and the higher divided voltage range II, and the same resistor string is shared to provide voltage dividing points the red sub-pixel, green sub-pixel, and blue sub-pixel need respectively in the middle divided voltage range III. If there are 32 voltage dividing points disposed in each resistor strip in the lower divided voltage range I and the higher divided voltage range II, and 191 voltage dividing points are disposed on the shared resistor strip in the middle divided voltage range III, the total voltage dividing points will be 32*3+32*3+191=383 voltage dividing points, as shown in FIG. 3B.

Compared to the prior art, only 383 voltage dividing points is needed in the invention to achieve the effect of improving the color shift phenomenon, it is fewer than the 765 voltage dividing points needed in the prior art. By doing so, the invention can largely reduce the number of the total voltage dividing points of the resistor strips, and the total area needed for the resistor strips will be smaller than the prior art. Therefore, the area used by the DAC in the source driver can be largely reduced than the prior art to avoid the waste of the layout space of the DAC in the prior art.

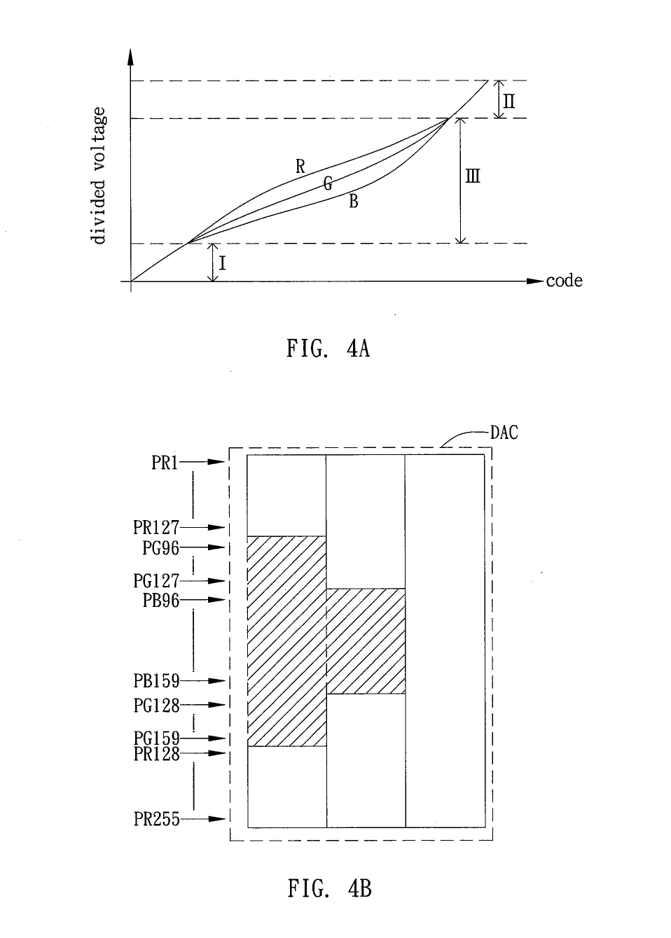

The above-mentioned FIG. 3A shows that the R, G, B gamma curves share the middle divided voltage range III. However, in practical applications, the R, G, B gamma curves can share any regions of the R, G, B gamma curves without any limitations. For example, as shown in FIG. 4A, the R, G, B gamma curves share the divided voltage ranges I and II. As shown in FIG. 4B, if 191 voltage dividing points are disposed on the resistor strip in the lower divided voltage range I and the higher divided voltage range II, and 64 voltage dividing points are disposed on each resistor strip in the divided voltage range III, there will be totally 64*3+191=383 voltage dividing points.

In practical applications, in the lower divided voltage range I and the higher divided voltage range II, any two gamma curves having smaller distance between them can be selected to share the same resistor strip to provide voltage dividing points based on the practical distribution of the R, G, B gamma curves. In the divided voltage range III, the R, G, B gamma curves share the same resistor strip to provide voltage dividing points. That is to say, any two gamma curves having smaller distance between them can be considered as the same gamma curve, and share the same resistor strip to provide voltage dividing points in all voltage dividing ranges.

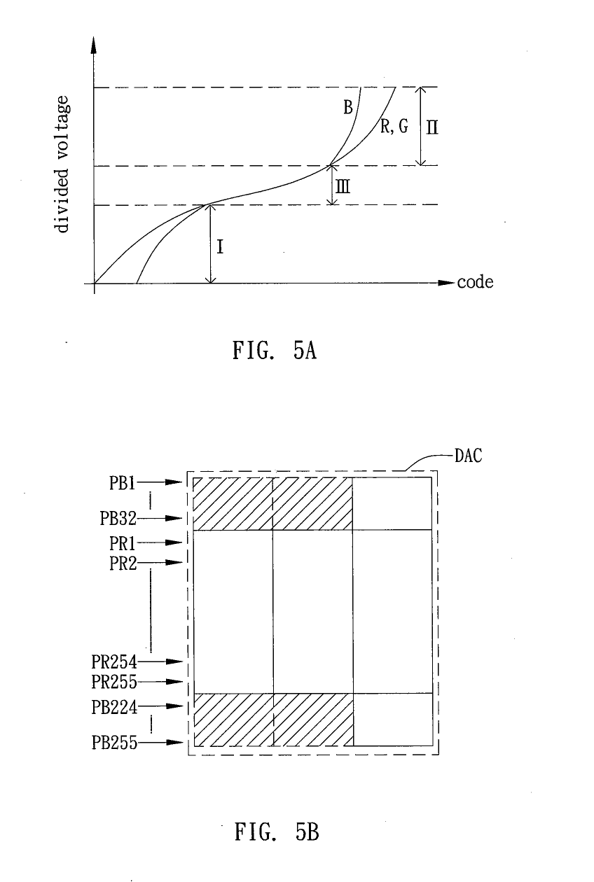

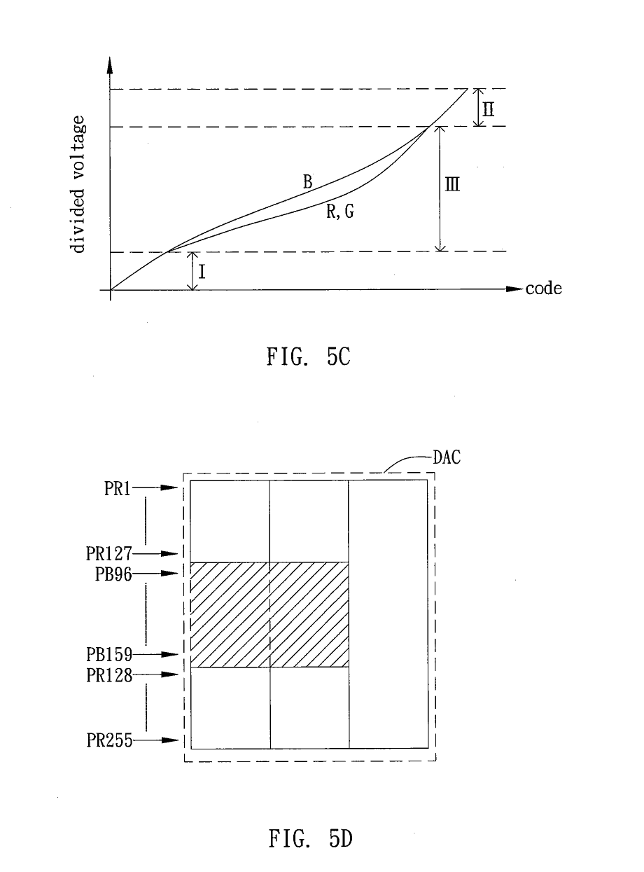

For example, as shown in FIG. 5A, because the R curve and the G curve are very close, the R curve and the G curve can be considered as the same gamma curve, and share the same resistor strip to provide voltage dividing points in the voltage dividing ranges I, II, and III. The B curve shares the same resistor strip with the R curve and the G curve in the voltage dividing range III to provide voltage dividing points, but the B curve uses another resistor strip in the voltage dividing ranges I and II to provide voltage dividing points. If 32 voltage dividing points are disposed on each resistor strip in the lower divided voltage range I and the higher divided voltage range II, and 191 voltage dividing points are disposed on the shared resistor strip in the divided voltage range III, there will be totally 32*2+32*2+191=319 voltage dividing points, as shown in FIG. 5B. It is not only fewer than the 765 voltage dividing points needed in the prior art, but also fewer than the 383 voltage dividing points needed in FIG. 3A. Therefore, it can further reduce the area used by the DAC in the source driver to effectively avoid the waste of the layout space of the DAC.

In practical applications, it is not limited to that the R curve and the G curve share the same resistor strip to provide voltage dividing points as shown in FIG. 5A, it can also be the R curve and the B curve share the same resistor strip to provide voltage dividing points, or the G curve and the B curve share the same resistor strip to provide voltage dividing points depending on the practical distribution of the R, G, B curves.

The above-mentioned FIG. 5A shows an embodiment that the R, G curves share the same resistor strip with the B curve in the middle divided voltage range III. However, in practical applications, the shared region can be any regions on the R, G curves and the B curve without specific limitations. For example, as shown in FIG. 5C, the R, G curves share the same resistor strip with the B curve in the divided voltage ranges I and II. If 191 voltage dividing points are disposed on the same resistor strip in the lower divided voltage range I and the higher divided voltage range II, and 64 voltage dividing points are disposed on each resistor strip in the divided voltage range III, there will be totally 64*2+191=319 voltage dividing points, as shown in FIG. 5D.

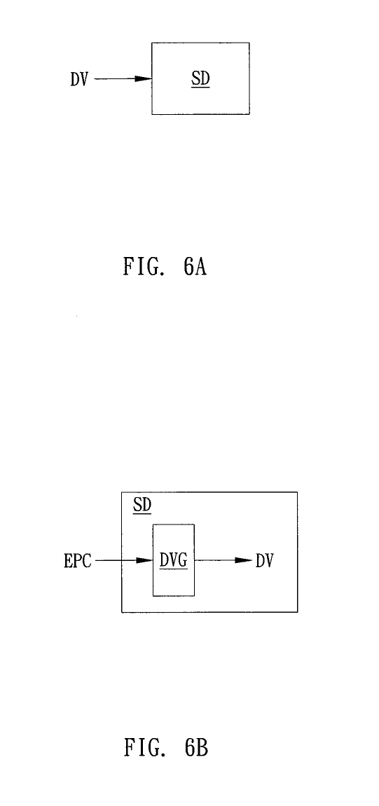

In addition, as shown in FIG. 6A and FIG. 6B, the divided voltage DV provided to the voltage dividing resistor strings can be directly provided into the source driver SD from outside, or generated by a divided voltage generator DVG in the source driver SD according to an outside programming command EPC.

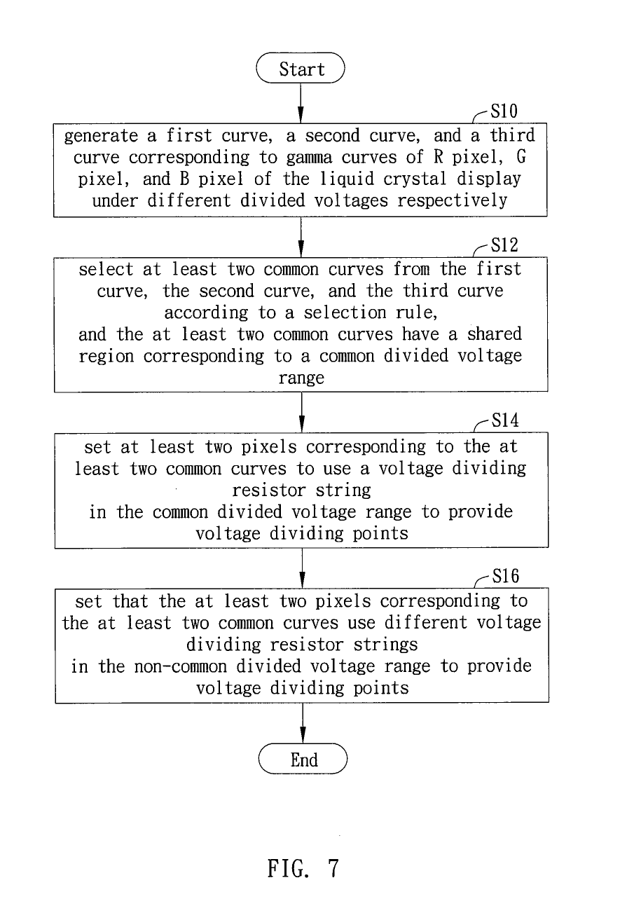

A second embodiment of the invention is a voltage selection method. In this embodiment, the voltage selection method is applied in a driving circuit of a liquid crystal display. Please refer to FIG. 7. FIG. 7 shows the flow chart of the voltage selection method. As shown in FIG. 7, at first, the step S10 is performed to generate a first curve, a second curve, and a third curve corresponding to gamma curves of R pixel, G pixel, and B pixel of the liquid crystal display under different divided voltages respectively. That is to say, the first curve, the second curve, and the third curve are the R curve, the G curve, and the B curve respectively.

Then, the step S12 is performed to select at least two common curves from the first curve, the second curve, and the third curve according to a selection rule, and the at least two common curves have a shared region corresponding to a common divided voltage range. In fact, the selection rule can be related to a degree of closeness or a degree of similarity among the first curve, the second curve, and the third curve, but not limited to this.

In practical applications, the at least two common curves selected in step S12 can be a combination of two curves or three curves. For example, the at least two common curves can be the three-curve combination of the first curve (R curve), the second curve (G curve), and the third curve (B curve); the at least two common curves can be also the two-curve combination of the first curve (R curve) and the second curve (G curve), the two-curve combination of the first curve (R curve) and the third curve (B curve), or the two-curve combination of the second curve (G curve) and the third curve (B curve).

Then, the step S14 is performed to set at least two pixels corresponding to the at least two common curves to use a voltage dividing resistor string in the common divided voltage range to provide voltage dividing points. For example, if the at least two common curves is the two-curve combination of the first curve (R curve) and the second curve (G curve), then the corresponding sub-pixels are the R sub-pixel and the G sub-pixel, and so on.

In practical applications, the divided voltage provided to the voltage dividing resistor string can be directly provided into the driving circuit from outside, or generated by a divided voltage generator in the driving circuit via a way of outside programming.

It should be noticed that the shared region can include all of the at least two common curves or a part of the at least two common curves. If the shared region can include all of the at least two common curves, these at least two common curves can be considered as the same curve.

If the shared region includes a part of the at least two common curves, it means that the at least two common curves also have a non-shared region corresponding to a non-common divided voltage range. The non-shared region can be any regions on the at least two common curves, for example, two ends or the middle region of the at least two common curves without any limitations. At this time, the step S16 is performed to set that the at least two pixels corresponding to the at least two common curves use different voltage dividing resistor strings in the non-common divided voltage range to provide voltage dividing points.

Compared to the prior art, in the voltage selection apparatus and the voltage selection method of the invention, at least two of the three gamma curves (R, G, B) will be close or overlapped in some divided voltage ranges, and the sub-pixels corresponding to the at least two of the three gamma curves will share the same resistor strip to provide voltage dividing points. Not only the divided voltages provided to the R sub-pixel, G sub-pixel, and B sub-pixel of each pixel of the liquid crystal display can be adjusted to solve the color shift problem, but also the area and the number of voltage dividing points needed for resistor strips can be reduced. Therefore, the area used by the digital-analog converter of the source driver will be reduced to prevent the waste of layout space of the digital-analog converter in conventional driving circuit.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

1. A voltage selection apparatus, applied in a driving circuit of a liquid crystal display, the voltage selection apparatus comprising:
a generating module, for generating a first curve, a second curve, and a third curve corresponding to gamma curves of R pixel, G pixel, and B pixel of the liquid crystal display under different divided voltages respectively;
a selection module, coupled to the generating module, for selecting at least two common curves from the first curve, the second curve, and the third curve according to a selection rule, and the at least two common curves have a shared region corresponding to a common divided voltage range; and
a setting module, coupled to the selection module, for setting at least two pixels corresponding to the at least two common curves to use a voltage dividing resistor string in the common divided voltage range to provide voltage dividing points.

2. The voltage selection apparatus of claim 1, wherein the at least two common curves is a combination of the first curve, the second curve, and the third curve, a combination of the first curve and the second curve, a combination of the first curve and the third curve, or a combination of the second curve and the second curve.

3. The voltage selection apparatus of claim 1, wherein the divided voltage provided to the voltage dividing resistor string is directly provided into the driving circuit from outside, or generated by a divided voltage generator in the driving circuit via a way of outside programming.

4. The voltage selection apparatus of claim 1, wherein the shared region comprises all of the at least two common curves.

5. The voltage selection apparatus of claim 1, wherein the shared region comprises a part of the at least two common curves, and the at least two common curves also have a non-shared region corresponding to a non-common divided voltage range.

6. The voltage selection apparatus of claim 5, wherein the setting module sets that the at least two pixels corresponding to the at least two common curves use different voltage dividing resistor strings in the non-common divided voltage range to provide voltage dividing points.

7. The voltage selection apparatus of claim 1, wherein the selection rule is related to a degree of closeness or a degree of similarity among the first curve, the second curve, and the third curve.

8. A voltage selection method, applied in a driving circuit of a liquid crystal display, the voltage selection method comprising steps of:
generating a first curve, a second curve, and a third curve corresponding to gamma curves of R pixel, G pixel, and B pixel of the liquid crystal display under different divided voltages respectively;
selecting at least two common curves from the first curve, the second curve, and the third curve according to a selection rule, and the at least two common curves have a shared region corresponding to a common divided voltage range; and
setting at least two pixels corresponding to the at least two common curves to use a voltage dividing resistor string in the common divided voltage range to provide voltage dividing points.

9. The voltage selection method of claim 8, wherein the at least two common curves is a combination of the first curve, the second curve, and the third curve, a combination of the first curve and the second curve, a combination of the first curve and the third curve, or a combination of the second curve and the second curve.

10. The voltage selection method of claim 8, wherein the divided voltage provided to the voltage dividing resistor string is directly provided into the driving circuit from outside, or generated by a divided voltage generator in the driving circuit via a way of outside programming.

11. The voltage selection method of claim 8, wherein the shared region comprises all of the at least two common curves.

12. The voltage selection method of claim 8, wherein the shared region comprises a part of the at least two common curves, and the at least two common curves also have a non-shared region corresponding to a non-common divided voltage range.

13. The voltage selection method of claim 12, further comprising step of:
setting that the at least two pixels corresponding to the at least two common curves use different voltage dividing resistor strings in the non-common divided voltage range to provide voltage dividing points.

14. The voltage selection method of claim 8, wherein the selection rule is related to a degree of closeness or a degree of similarity among the first curve, the second curve, and the third curve.
